(19) United States
(12) Patent Application Publication
(10) Pub. No.: US 2017/0168452 A1
(43) Pub. Date: Jun. 15, 2017

(54) ILLUMINATION APPARATUS AND DISPLAY APPARATUS

(71) Applicant: OLYMPUS CORPORATION, Tokyo (JP)

(72) Inventor: Keigo MATSUO, Tokyo (JP)

(73) Assignee: OLYMPUS CORPORATION, Tokyo (JP)

(21) Appl. No.: 15/436,750

(22) Filed: Feb. 17, 2017

Related U.S. Application Data
(63) Continuation of application No. PCT/JP2014/004923, filed on Sep. 25, 2014.

(51) Int. Cl. G03H 1/22; G03H 1/02; F21V 8/00

(52) U.S. Cl. CPC G03H 1/2286; G02B 6/0076; G02B 6/005; G03H 1/2294; G03H 1/02; G03H 2223/23; G03H 2223/16; G03H 2222/34; G03H 2001/0212; G03H 2001/0216; G03H 2001/0224; G03H 2225/34; G03H 2225/61; G03H 2226/02

(57) ABSTRACT

Provided are an illumination apparatus that allows a reduction in thickness and a display apparatus that uses the illumination apparatus. The illumination apparatus includes a laminated illumination portion formed by layering illumination portions that each emit illumination light as a plane wave with a different wavelength. The illumination portions include light sources that emit light of a predetermined wavelength, optical waveguides that propagate the light emitted from the light sources, and gratings that diffract the light propagating through the optical waveguides and emit the light as the illumination light.

### CROSS REFERENCE TO RELATED APPLICATIONS

The present application is a Continuing Application based on international Application PCT/JP2014/004923 filed on Sep. 25, 2014, the entire disclosures of which is incorporated herein by reference.

### TECHNICAL FIELD

This disclosure relates to an illumination apparatus and a display apparatus that uses the illumination apparatus.

### BACKGROUND

For example, an illumination apparatus that emits illumination light in plane form has been proposed (see JP H3-198023 A (PTL 1)). The illumination apparatus disclosed in PTL 1 includes two beam expanding optical elements that each expand an incident light beam in a 1D direction with a grating or a hologram. With these two beam expanding optical elements, the illumination apparatus sequentially expands the incident light beam in different directions and then emits the light beam.

### CITATION LIST

### Patent Literature

PTL 1: JP 143-198023 A

### SUMMARY

PTL 1 discloses an illumination apparatus that emits monochrome illumination light but makes no mention of a structure for emitting multicolored illumination light. In the case of obtaining multicolored illumination light by applying the technique disclosed in PTL 1, it is envisioned that a plurality of combinations of two beam expanding optical elements would be prepared in correspondence with different wavelengths of illumination light.

In this case, however, six beam expanding optical elements are necessary to obtain illumination light of three colors, such as red (R) light, green (G) light, and blue (B) light. Furthermore, optical elements such as reflective mirrors, dichroic mirrors, or the like are also necessary to guide the illumination light from each combination to a predetermined emission region. Therefore, in particular the depth dimension of the apparatus as viewed in the emission direction of the illumination light grows large, leading to an increase in size of the illumination apparatus. The same is also the case when obtaining multicolored illumination light in the form of a line (band) and is also the case in a display apparatus that uses illumination light.

It would therefore be helpful to provide an illumination apparatus that allows a reduction in thickness and a display apparatus that uses the illumination apparatus.

An illumination apparatus according to this disclosure comprises:

a laminated illumination portion formed by layering a plurality of illumination portions each configured to emit illumination light as a plane wave with a different wavelength;

wherein each illumination portion comprises a light source configured to emit light of a predetermined wavelength, an optical waveguide configured to propagate the light emitted from the light source, and a grating configured to diffract the light propagating through the optical waveguide and emit the light as the illumination light.

The laminated illumination portion may emit the illumination light with a different wavelength from each illumination portion in a same direction.

The optical waveguide may be formed by a single mode optical waveguide.

The optical waveguide may be formed by a slab-type optical waveguide.

The grating may increase in height in a propagation direction of the light that propagates through the optical waveguide.

In the laminated illumination portion, the plurality of illumination portions may be layered in order in a direction of emission of the light, in order of decreasing wavelength of the illumination light.

A display apparatus according to this disclosure comprises:

the aforementioned illumination apparatus comprising the laminated illumination portion;

a calculator configured to calculate an amount of modulation necessary to form a wavefront shape of a display light beam at each wavelength of the illumination light from the illumination apparatus;

a spatial light modulator configured to subject the illumination light from the illumination apparatus to spatial modulation based on the amount of modulation calculated by the calculator; and

a controller configured to control driving of the laminated illumination portion of the illumination apparatus and the spatial light modulator;

wherein the calculator calculates the amount of modulation necessary tier each wavelength of the illumination light in accordance with a display image; and

wherein the controller drives the illumination portions of the laminated illumination portion and the spatial light modulator in synchronization at each wavelength of the illumination light in accordance with the display image.

A display apparatus according to this disclosure comprises:

the aforementioned illumination apparatus comprising the laminated illumination portion;

a display configured to display an image with the illumination light from the illumination apparatus;

a projection optical unit configured to project an image formed on the display; and

a controller configured to control driving of the laminated illumination portion of the illumination apparatus and the display;

wherein the controller drives the illumination portions of the laminated illumination portion and the display in synchronization at each wavelength of the illumination light.

With this disclosure, an illumination apparatus that allows a reduction in thickness and a display apparatus that uses the illumination apparatus can be provided.

### BRIEF DESCRIPTION OF THE DRAWINGS

In the accompanying drawings:

FIG. 1 is a cross-sectional diagram schematically illustrating the structure of an illumination apparatus according to Embodiment 1;

FIG. 2A illustrates an example of forming the grating in FIG. 1;

FIG. 2B illustrates an example of forming the grating in FIG. 1;

FIG. 2C illustrates an example of forming the grating in FIG. 1;

FIG. 2D illustrates an example of forming the grating in FIG. 1;

FIG. 3 illustrates the function of the illumination portions in FIG. 1;

FIG. 4 is a cross-sectional diagram schematically illustrating the structure of an illumination apparatus according to Embodiment 2;

FIG. 5 is a perspective view illustrating the basic structure of a slab-type optical waveguide;

FIG. 6A is an expanded schematic view of an illumination portion in FIG. 4 as seen from the z-direction;

FIG. 6B is an expanded schematic view of an illumination portion in FIG. 4 as seen from the x-direction;

FIG. 7 is a cross-sectional diagram schematically illustrating the structure of an illumination apparatus according to Embodiment 3;

FIG. 8A is an expanded schematic view of an illumination portion in FIG. 7 as seen from the z-direction;

FIG. 8B is an expanded schematic view of an illumination portion in FIG. 7 as seen from the x-direction;

FIG. 9A illustrates the grating height of an illumination apparatus according to Embodiment 4;

FIG. 9B illustrates grating with constant height;

FIG. 10 illustrates an intensity distribution of illumination light diffracted by the grating in FIG. 9A and FIG. 9B;

FIG. 11 schematically illustrates the structure of a display apparatus according to Embodiment 5;

FIG. 12A is a schematic cross-sectional diagram of the spatial light modulator in FIG. 11;

FIG. 12B is a schematic plan view of the spatial light modulator in FIG. 11;

FIG. 13A illustrates the main routine to reproduce a holographic image with the display apparatus in FIG. 11;

FIG. 13B illustrates a subroutine to reproduce a holographic image with the display apparatus in FIG. 11;

FIG. 14A illustrates an example of an image to be reproduced by the display apparatus in FIG. 11;

FIG. 14B illustrates an example of a hologram pattern formed on the spatial light modulator in FIG. 11;

FIG. 15 illustrates image reproduction on the eyeball of an observer from the spatial light modulator in FIG. 11; and

FIG. 16 schematically illustrates the structure of a display apparatus according to Embodiment 6.

### DETAILED DESCRIPTION

The following describes embodiments with reference to the drawings.

### Embodiment 1

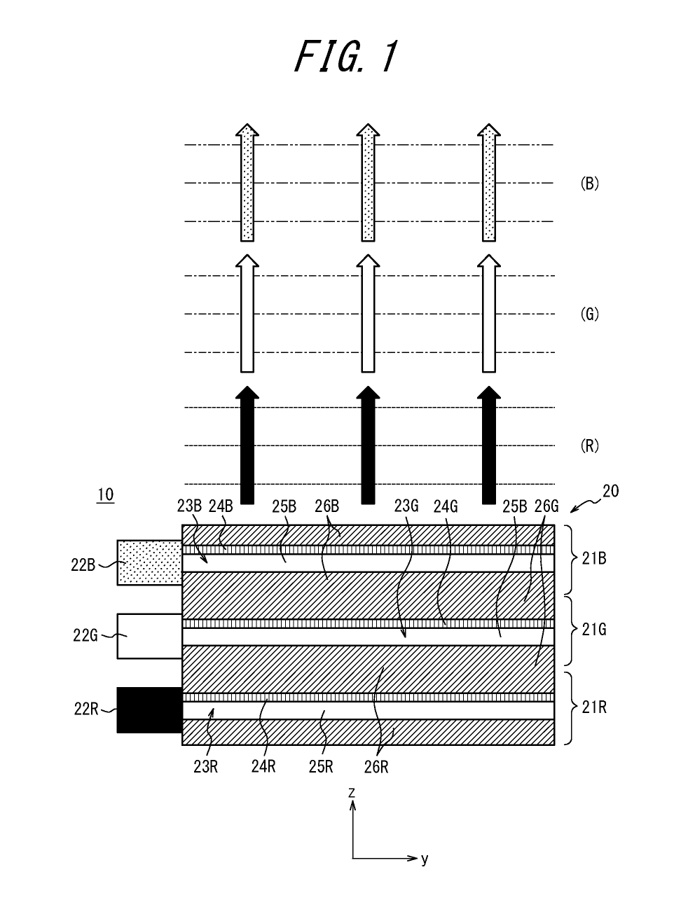

FIG. 1 is a cross-sectional diagram schematically illustrating the structure of an illumination apparatus according to Embodiment 1. An illumination apparatus 10 according to Embodiment 1 includes a laminated illumination portion 20. The laminated illumination portion 20 includes an illumination portion 21R that emits illumination light in a plane wave of R light, an illumination portion 21G that emits illumination light in a plane wave of G light, and an illumination portion 21B that emits illumination light in a plane wave of B light. The illumination portions 21R, 21G, and 21B are layered in the order of decreasing wavelength of emitted illumination light and emit the illumination light in the same direction along the z-direction. Accordingly, in FIG. 1, the illumination portion 21G is layered on the illumination light emission side of the illumination portion 21R, and the illumination portion 21B is layered on the illumination light emission side of the illumination portion 21G.

The illumination portion 21R includes a light source 22R that emits R light, an optical waveguide 23R that propagates R light from the light source 22R in the y-direction, and a grating 24R that diffracts the R light propagating through the optical waveguide 23R and emits the R light as illumination light in a plane wave expanded in the y-direction. The light source 22R is for example configured to include a semiconductor laser and is joined to the incident end of the optical waveguide 23R. The optical waveguide 23R is structured to include a core 25R and a cladding 26R. A cross-section of the core 25R in a direction (x-direction) orthogonal to the propagating direction (y-direction) of the R light may be formed in any shape, such as a circle, ellipse, rectangle, or the like. The cladding 26R is formed around the core 25R, except for the edges thereof in the y-direction, at least above and below the emission region of illumination light. Note that FIG. 1 is a cross-sectional diagram of the yz plane of the laminated illumination portion 20.

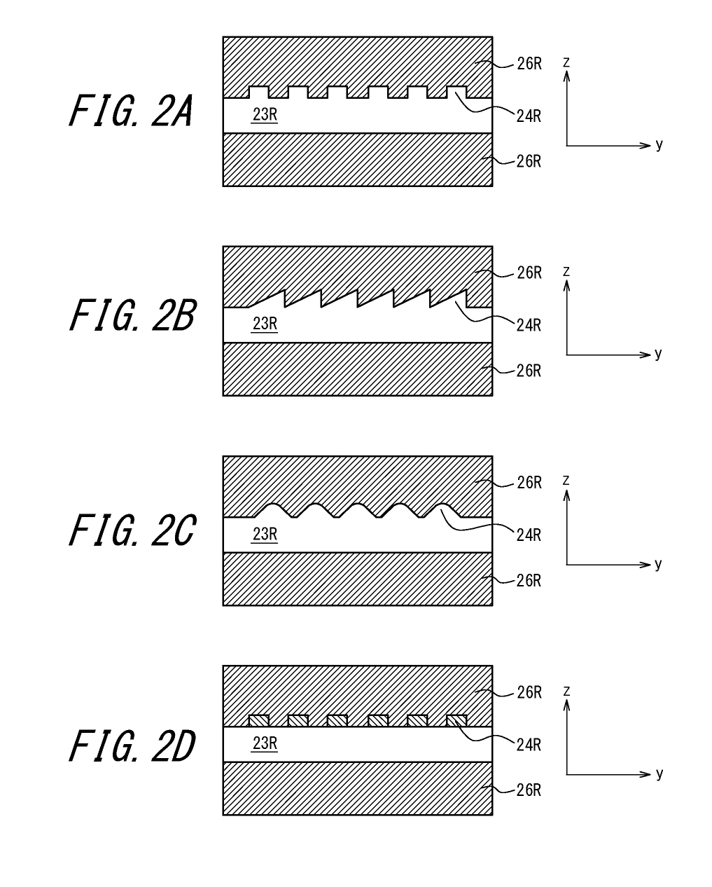

In order to emit R light in a plane wave in the z-direction, the grating 24R is formed in the y-direction at the interface between the core 25R and the cladding 26R, or within the core 25R, in the propagation path of illumination light in the optical waveguide 23R. The grating 24R may for example be formed as rectangular grooves as illustrated in FIG. 2A, as saw-tooth shaped grooves as illustrated in FIG. 2B, as wave-shaped grooves as illustrated in FIG. 2C, or as rectangular grooves with different refractive indices, as illustrated in FIG. 2D.

The illumination portion 21G is configured similarly to the illumination portion 21R and includes a light source 22G that emits G light, an optical waveguide 23G that has a core 25G and a cladding 26G that propagate G light from the light source 22G in the y-direction, and a grating 24G that diffracts the G light propagating through the optical waveguide 23G and emits the G light as illumination light in a plane wave expanded in the y-direction. The illumination portion 21B is configured similarly to the illumination portion 21R and includes a light source 22B that emits B light, an optical waveguide 23B that has a core 25B and a cladding 26B that propagate B light from the light source 22B in the y-direction, and a grating 24B that diffracts the B light propagating through the optical waveguide 23B and emits the B light as illumination light in a plane wave expanded in the y-direction. In FIG. 1, the cladding 26R at the upper side of the optical waveguide 23R and the cladding 26G at the lower side of the optical waveguide 23G are joined, and the cladding 26G at the upper side of the optical waveguide 23G and the cladding 26B at the lower side of the optical waveguide 23B are joined.

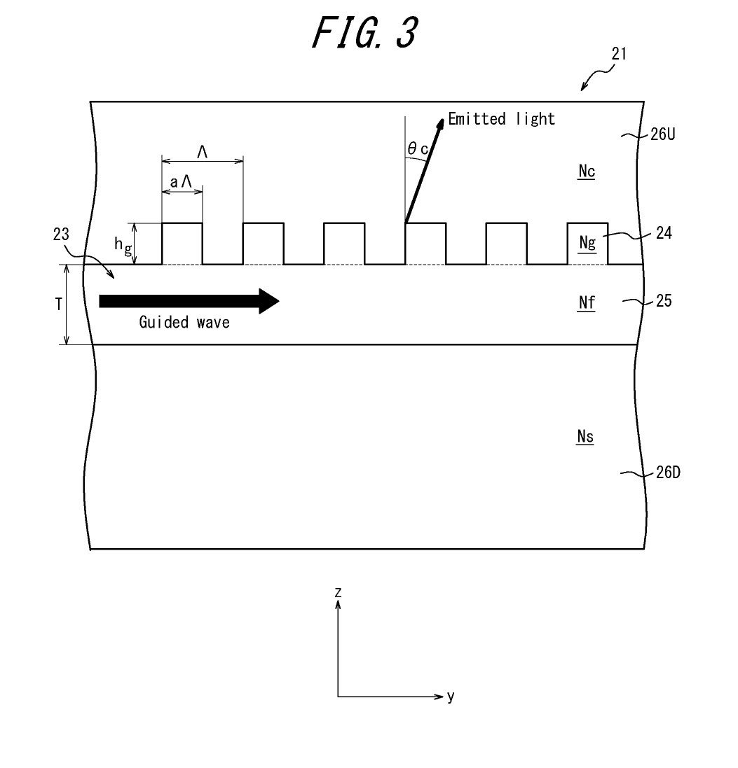

Next, the function of the illumination portions 21R, 21G, and 21B is illustrated with reference to FIG. 3. In the illumination portion 21 illustrated in FIG. 3, a core 25 with a thickness T and a refractive index Nf is layered on a lower cladding 26D with a refractive index Ns. A grating 24 with a refractive index Ng, interval Λ, grating factor a, and height hg is layered on the core 25, and an upper cladding 26U with a refractive index Nc is further layered on the grating 24. The cladding 26D, core 25, and cladding 26U constitute the optical waveguide 23.

In FIG. 3, the light incident on the optical waveguide 23 (wavelength λ) is confined by repeatedly being totally reflected at the interfaces between the core 25 at the claddings 26D and 26U, which all have different refractive indices, and propagates in the optical waveguide 23 in a waveguide mode. Once the light that propagates in the optical waveguide 23 satisfies the condition in Equation (1) below at a portion where the grating 24 with an interval Λ is disposed, the waveguide mode joins with an emission mode. As a result, when a guided wave having a propagation constant β₀ in the y-direction propagates through the optical waveguide 23, a spatial harmonic incidental to the guided wave occurs. The spatial harmonic has a propagation constant β_{q} in the y-direction. The light propagating through the optical waveguide 23 at this time is emitted by the emission mode to the outside of the illumination portion 21 at an emission angle (θc) as a plane wave in a band (1D shape).

$$Nc \cdot {k}_{0} \cdot sin {θ}_{c} = {β}_{0} + qK ( q = 0 , \pm 1 , \pm 2 , ⋯ ) \\ {B}_{0} = {N}_{eff} \cdot {k}_{0} \\ K = \frac{2 π}{Λ} \qquad ( 1 )$$

where k₀ is the vacuum wavenumber, and N_{eff} is the effective refractive index of the guided wave

Here, the propagation mode of the guided wave propagating through the optical waveguide 23 in the y-direction can be separated into multimode propagation, in which a plurality of propagation constants exist, and single mode propagation, in which only one propagation constant of the fundamental mode exists, based on parameter conditions (refractive index, thickness, wavelength) constituting the optical waveguide 23.

When plane waves with a plurality of emission angles are to be emitted from the illumination portion 21, for example, a grating 24 with interval Λ is formed so that one value of q in Equation (1) holds for a specific propagation mode, and multimode light is propagated. In this case, since light is emitted to the outside of the optical waveguide 23 by the emission mode incidentally to propagation light in each mode, plane waves with a plurality of emission angles can ultimately be emitted from the illumination portion 21. Alternatively, a grating 24 with interval Λ may be formed so that a plurality of values of q in Equation (1) hold, and single mode light may be propagated. In this case, since light is emitted to the outside of the optical waveguide 23 by q-degree emission modes incidentally to propagation light, plane waves with a plurality of emission angles can ultimately be emitted from the illumination portion 21.

In this embodiment, only a plane wave with a specific emission angle (θc) is output from the illumination portion 21. In this case, for a specific propagation mode, a grating 24 with interval Λ may be formed so that one value of q in Equation (1) holds, and single mode light may be propagated. According to this structure, since light is emitted to the outside of the optical waveguide 23 by a specific emission mode incidentally to propagation light, only a plane wave with a specific emission angle can ultimately be emitted from the illumination portion 21.

Therefore, in the illumination apparatus 10 illustrated in FIG. 1, the illumination portions 21R, 21G; and 21B are configured as described below as an example. The illumination portion 21R is configured so that the wavelength of R light (λ_{R}) emitted from the light source 22R is λ_{R}=632.8 nm, the refractive index of the core 25R (Nf) and the refractive index of the grating 24R (Ng) are Nf=Ng=1.5311, the refractive indices of the lower and upper claddings 26R (Ns, Nc) are Ns=Nc=1.45671, and the interval (Λ) of the grating 24R is Λ=394 nm. in this case, the effective refractive index N_{eff} of the optical waveguide 23R is N_{eff}=1.50428, and the emission angle (θc) of illumination light is θc=−4.0′. The grating factor a and the height hg of the grating are a=0.5 and hg=50 nm. A negative angle for the emission angle θc represents clockwise rotation about the z-direction in FIG. 3.

The illumination portion 21G is configured so that the wavelength of G light (λ_{G}) emitted from the light source 22G is λ_{G}=546.074 nm, the refractive index of the core 25G (NI) and the refractive index of the grating 24G (Ng) are Nf=Ng=1.5354, the refractive indices of the lower and upper claddings 26G (Ns, Nc) are Ns=Nc=1.46008, and the interval (Λ) of the grating 24G is Λ=339 nm. In this case, the effective refractive index N_{eff} of the optical waveguide 23G is N_{eff}=1.50788, and the emission angle (θc) of illumination light is θc=−4.0′. The grating factor a and the height hg of the grating are a=0.5 and hg=50 nm.

The illumination portion 219 is configured so that the wavelength of B light (λ_{B}) emitted from the light source 229 is λ_{B}=435.834 nm, the refractive index of the core 25B (Nf) and the refractive index of the grating 249 (Ng) are Nf=Ng=1.544, the refractive indices of the lower and upper claddings 26B (Ns, Nc) are Ns=Nc=1.46669, and the interval (Λ) of the grating 24B is Λ=269 nm. In this case, the effective refractive index N_{eff} of the optical waveguide 239 is N_{eff}=1.517, and the emission angle (θc) of illumination light is θc=−4.0′. The grating factor a and the height hg of the grating are a=0.5 and hg=50 nm.

The emission angle θc of illumination light may of course be 0′.

As a result, in FIG. 1, the R light emitted from the illumination portion 21R passes through the illumination portions 21G and 21B and is emitted. The G light emitted from the illumination portion 21G passes through the illumination portion 21B and is emitted in the same direction as the R light.

Also, the B light emitted from the illumination portion 21B passes through the illumination portion 21B and is emitted in the same direction as the emitted R. light and B light. In FIG. 1, the images of plane waves of the emitted R light, G light, and. B light are respectively indicated by dashed lines, dashed dotted lines, and dashed double-dotted lines.

With the illumination apparatus 10 according to this embodiment, the illumination portion 21R that includes the light source 22R, optical waveguide 23R, and grating 24R, the illumination portion 21G that includes the light source 22G; optical waveguide 23G, and grating 24G, and the illumination portion 21B that includes the light source 22B, optical waveguide 23B, and grating 24B are layered in the laminated illumination portion 20, from which illumination light in plane waves of R light, G light, and B light can be emitted in a band in the same direction. Accordingly, the illumination apparatus 10 can be reduced in thickness and in size.

### Embodiment 2

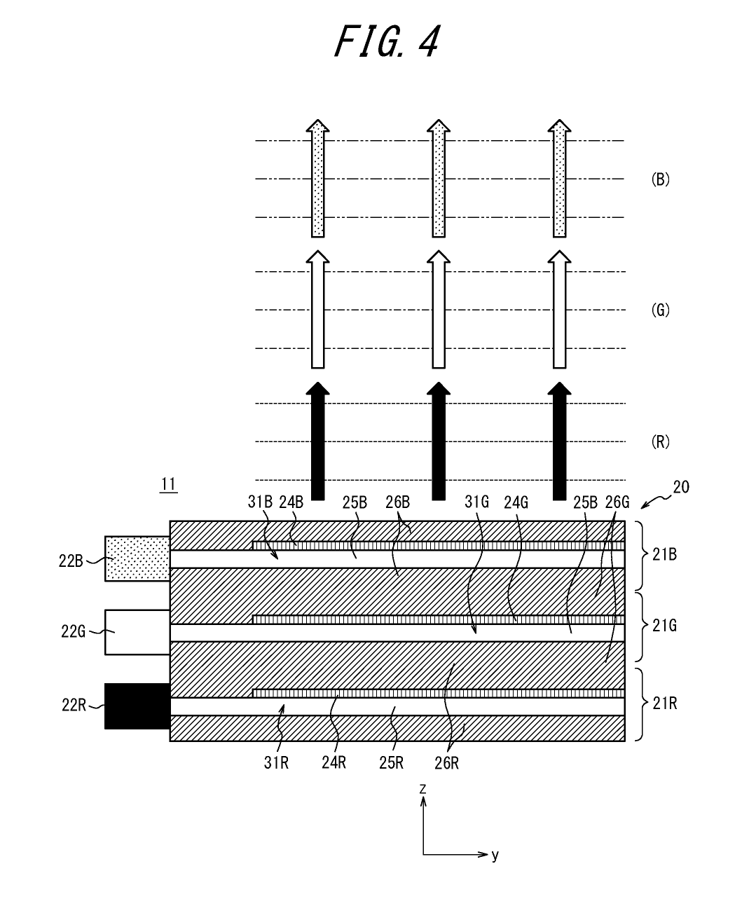

FIG. 4 is a cross-sectional diagram schematically illustrating the structure of an illumination apparatus according to Embodiment 2. An illumination apparatus 11 according to this embodiment has the structure of the illumination apparatus 10 according to Embodiment 1, except that the optical waveguides 23R, 23G, and 23B of the illumination portions 21R, 210; and 21B are configured as slab-type optical waveguides 31R, 310; and 31B, and illumination light in plane waves of R light, G light, and B light is emitted in plane form (a 2D shape) in the same direction.

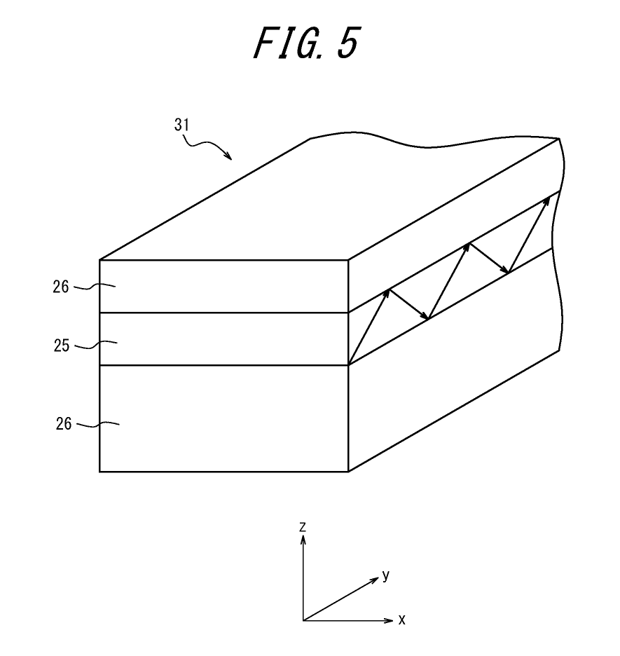

As illustrated in FIG. 5, the basic structure of the slab-type optical waveguide 31 includes a plate-shaped core 25 and claddings 26 layered on either surface thereof. In FIG. 5, the claddings are not formed at either of the end faces in the x-direction of the core 25, and a difference in refractive index between the core 25 and the claddings 26 exists in the z-direction, where the y-direction is the propagation direction of the guided wave, the z-direction is the direction of thickness of the core, and the x-direction is a direction orthogonal to the y-direction and the z-direction. The light guided into the core 25 from the y-direction is confined within the core 25 due to the difference in refractive index between the core 25 and the claddings 26 and propagates in the y-direction.

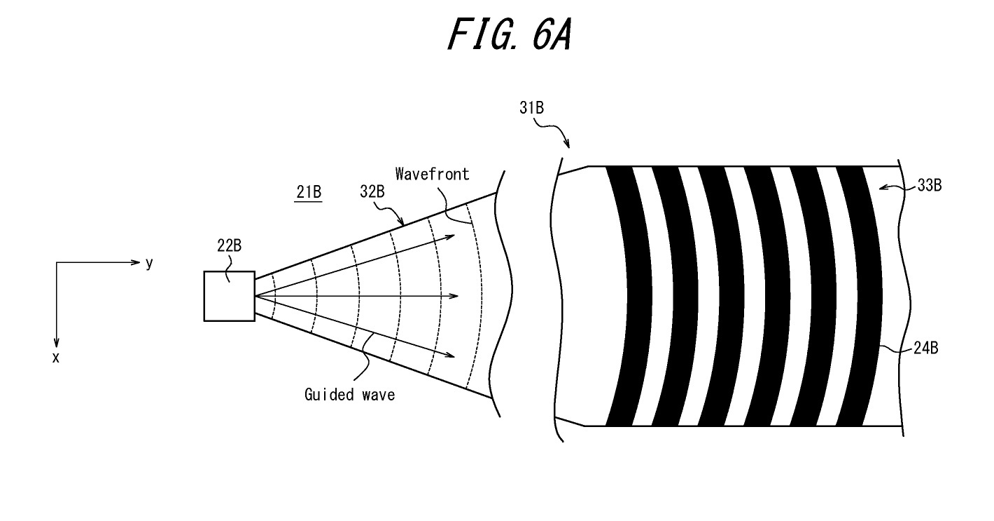

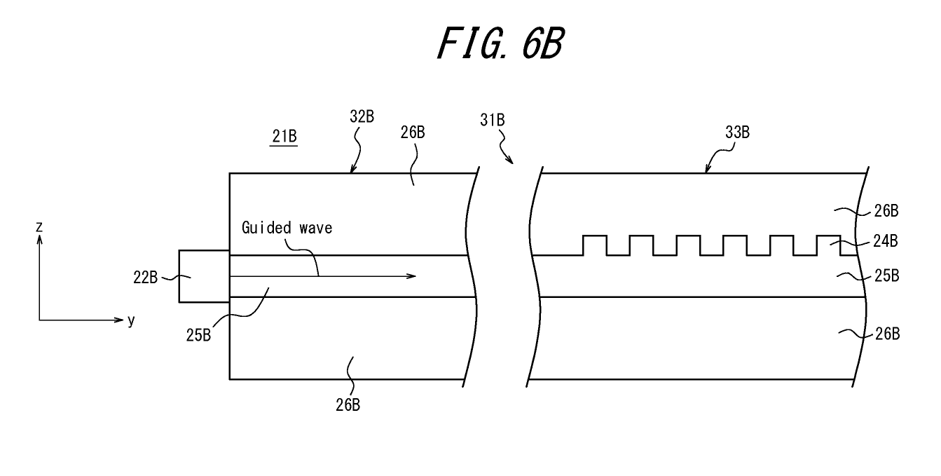

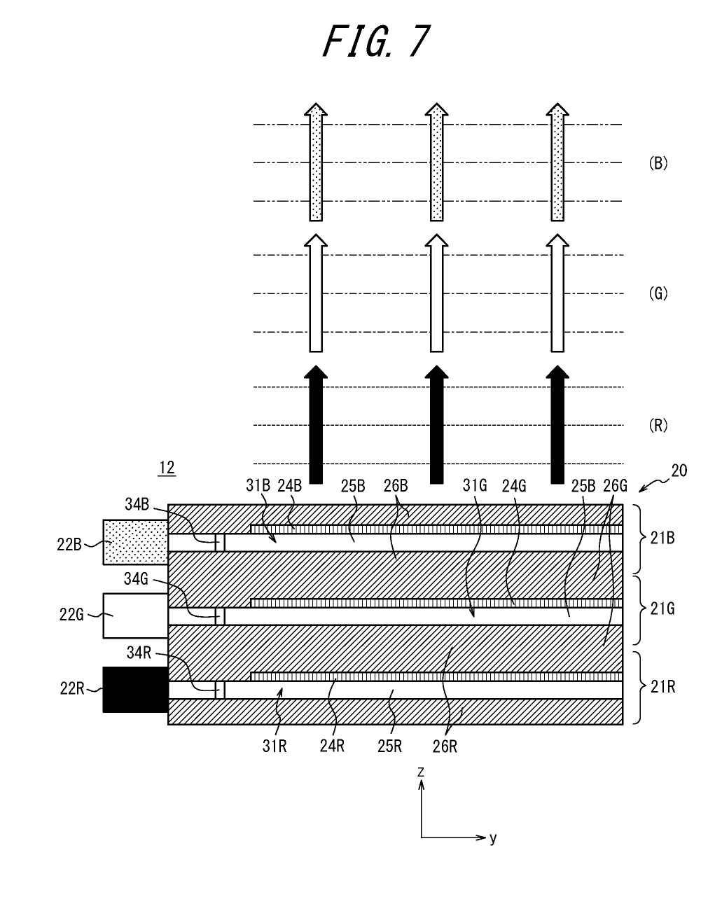

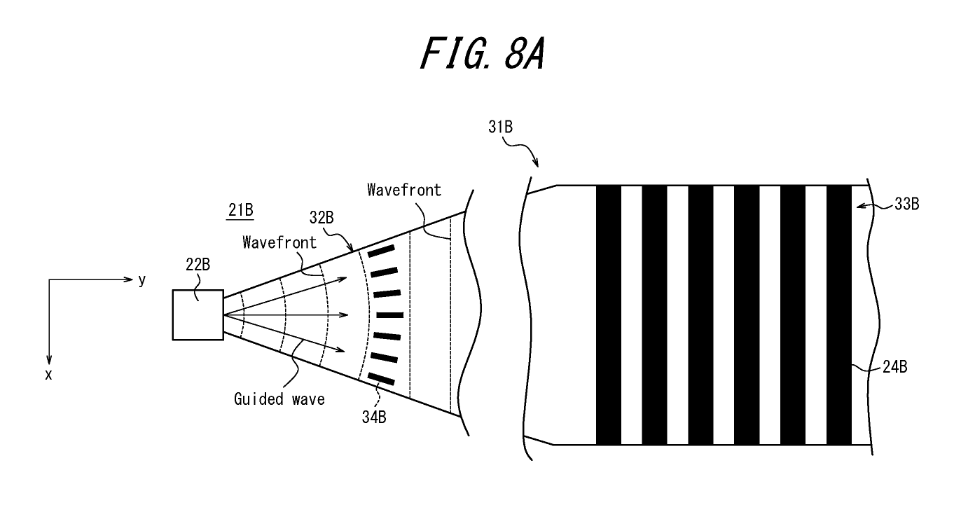

FIG. 6A is an expanded schematic view of the illumination portion 21B in FIG. 4 as seen from the z-direction, and FIG. 6B is an expanded schematic view as seen from the x-direction. The slab-type optical waveguide 31B includes a tapered optical waveguide 32B that expands from one end towards the other and a rectangular optical waveguide 33B joined to the expanded other end of the tapered optical waveguide 32B. The tapered optical waveguide 32B and the rectangular optical waveguide 33B include a core 25B extending in the xy plane and claddings 26B formed on surfaces of the core 25B that oppose each other in the z-direction. A grating 24B is formed on the rectangular optical waveguide 33B. The tapered optical waveguide 32B and the rectangular optical waveguide 33B are, for example, formed integrally, and the light source 22B is joined to one end of the tapered optical waveguide 32B.

In FIGS. 6A and 6B, the B light emitted from the light source 22B is confined in the z-direction in the tapered optical waveguide 32B and propagates in the y-direction. The B light emitted form the light source 22B propagates while spreading as a spherical wave in the x-direction, and the area thereof expands. The grating 24B is formed to have a predetermined shape (a rectangle in the figures) and interval in the yz plane and is formed to have a spherical shape aligned with the spherical wave shape of the guided wave in the xy plane.

The illumination portion 21G that has a slab-type optical waveguide 31G and the illumination portion 21R that has a slab-type optical waveguide 31R also have a similar structure to that of the illumination portion 21B illustrated in FIGS. 6A and 6B. Since the remaining structure is similar to that of Embodiment 1, a description thereof is omitted.

With the illumination apparatus 11 according to this embodiment, the illumination portion 21R that includes the light source 22R, slab-type optical waveguide 31R, and grating 24R, the illumination portion 21G that includes the light source 22G, slab-type optical waveguide 31G, and grating 24G, and the illumination portion 21B that includes the light source 22B, slab-type optical waveguide 31B, and grating 24B are layered in the laminated illumination portion 20, from which illumination light in plane waves of R light, G light, and B light can be emitted in plane form in the same direction. Accordingly, an illumination apparatus 11 that emits multicolored illumination light over a large area can be made thin and compact.

### Embodiment 3

FIG. 7 is a cross-sectional diagram schematically illustrating the structure of an illumination apparatus according to Embodiment 3. An illumination apparatus 12 according to this embodiment has the structure of the illumination apparatus 11 according to Embodiment 2, except that conversion gratings 34R, 34G, and 34B are respectively formed in the tapered optical waveguides 32R, 32G, and 32B that constitute the slab-type optical waveguides 31R, 31G, and 31B of the illumination portions 21R, 21G, and 21B.

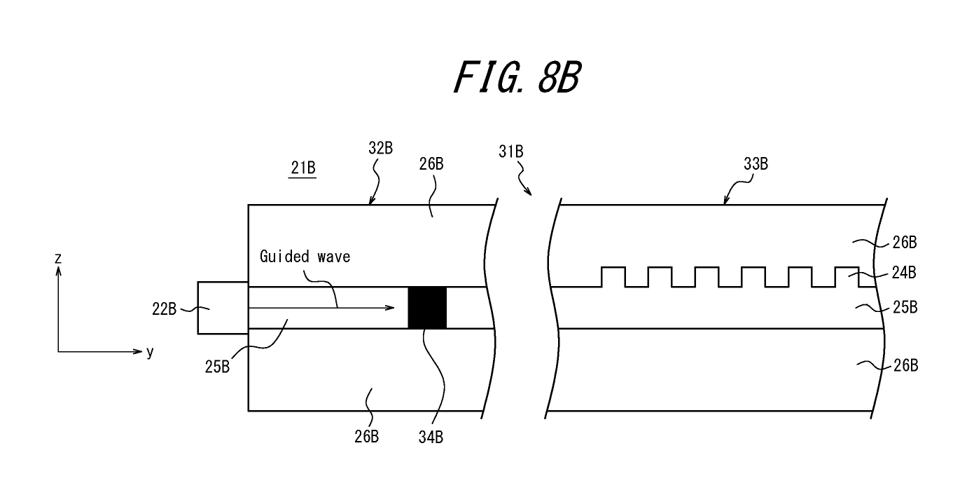

FIG. 8A is an expanded schematic view of the illumination portion 21B in FIG. 7 as seen from the z-direction, and FIG. 8B is an expanded schematic view as seen from the x-direction. The conversion grating 34B is formed at any position along the propagation path of B light in the tapered optical waveguide 32B and converts the B light propagating through the tapered optical waveguide 32B from a spherical wave to a plane wave in the xy plane. The grating 24B is formed to have a predetermined shape (a rectangle in the figures) and interval in the yz plane and is formed to have a linear shape aligned with the plane wave shape of the guided wave in the xy plane.

The conversion grating 34G and grating 24G of the illumination portion 21G and the conversion grating 34R and grating 24R of the illumination portion 21R are configured similarly to the conversion grating 34B and grating 24B of the illumination portion 21B. Since the remaining structure is similar to that of Embodiment 2, a description thereof is omitted.

In the illumination apparatus 12 according to this embodiment as well, as in the illumination apparatus 11 according to Embodiment 2, illumination light in plane waves of R light, G light, and B light can be emitted in plane form in the same direction from the laminated illumination portion 20. Accordingly, an illumination apparatus 12 that emits multicolored illumination light over a large area can be made thin and compact.

### Embodiment 4

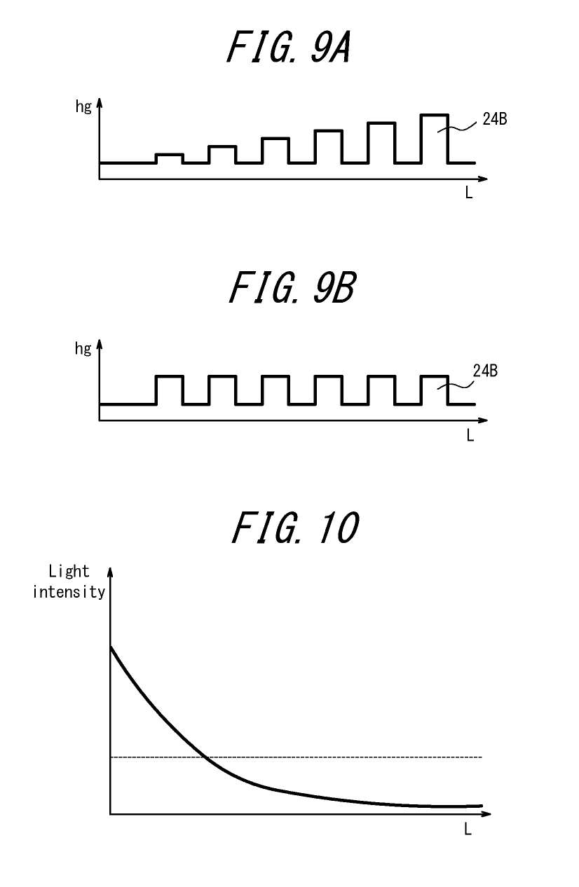

FIG. 9A illustrates an illumination apparatus according to Embodiment 4. In this embodiment, the height hg of the grating 24B of the illumination portion 21B in the illumination apparatus according to Embodiment 1 to Embodiment 3 is increased as the grating length L in the propagation direction (y-direction) of the guided wave increases.

In other words, as illustrated in FIG. 9B, when the height hg of the grating 24B is constant across the grating length L, the intensity of illumination light diffracted by the grating 24B and emitted from the illumination portion 21B diminishes exponentially, as indicated by the solid line in FIG. 10, as the grating length L increases in the propagation direction of the guided wave. Therefore, in this embodiment, so that the intensity of illumination light diffracted across the grating length L becomes nearly constant, as illustrated by the dashed line in FIG. 10, the height hg of the grating 24B is increased as the grating length L increases, as illustrated in FIG. 9A. The same is true for the gratings 24G and 24R of the illumination portions 21G and 21R. The remaining structure is similar to that of the corresponding embodiments above.

Accordingly, when applying this embodiment to the structure of Embodiment 1, the illumination light in plane waves of R light, G light, and B light can be emitted as a longer band with nearly constant intensity. When applying this embodiment to the structure of Embodiment 2 or Embodiment 3, the illumination light in plane waves of R light, G light, and B light can be emitted as a plane, with a large area, that is longer in the propagation direction and has nearly constant intensity.

As described above, the laminated illumination portion 20 is layered in the order of decreasing wavelength of emitted illumination light, i.e. starting from the lowest layer in the order of the illumination portions 21R, 21G, and 21B. Accordingly, even if the height hg of the gratings 24R, 24G, and 24B increases as the grating length L increases, unnecessary degrees of diffracted light can be prevented from occurring when the illumination light emitted from the illumination portion at a lower level passes through the illumination portion at an upper level.

### Embodiment 5

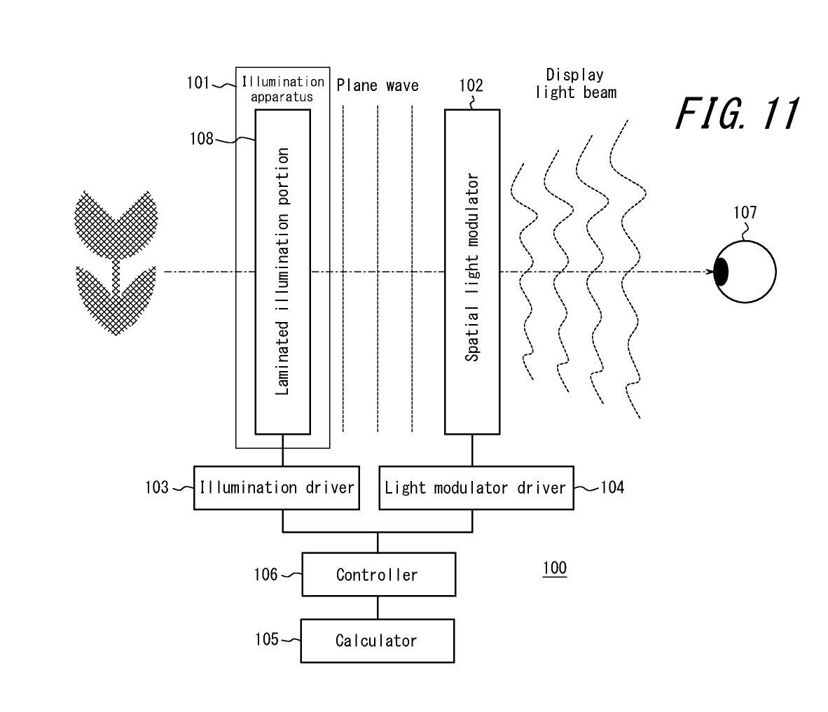

FIG. 11 schematically illustrates the structure of a display apparatus according to Embodiment 5. The display apparatus 100 illustrated in FIG. 11 has the structure of a holographic display device and includes an illumination apparatus 101, a spatial light modulator 102, an illumination driver 103, a light modulator driver 104, a calculator 105, and a controller 106. The illumination apparatus 101, spatial light modulator 102, illumination driver 103, light modulator driver 104, calculator 105, and controller 106 are for example disposed in a single housing, with the relative positions of the illumination apparatus 101 and the spatial light modulator 102 being fixed.

A display apparatus 100 according to this embodiment is geared towards a holographic image observed by reproducing an optical wavefront of an object using a computer-generated hologram technique. The object is a virtual object input into the calculator 105. Reproducing a holographic image refers to forming the optical wavefront that is formed when an object exists. As a result, an image of the object is formed on the retina of an observer's eyeball 107, and the observer can observe a virtual image of the object. The holographic image is not limited to being displayed as a 2D image in which the virtual image of the object to be displayed is disposed far away, in particular at infinity, and may instead be displayed as a 3D image.

The illumination apparatus 101 includes the illumination apparatus described in Embodiments 2 to 4 and a laminated illumination portion 108 that can emit illumination light in plane waves of R light, G light, and B light in plane form in the same direction. The laminated illumination portion 108 is driven by the illumination driver 103.

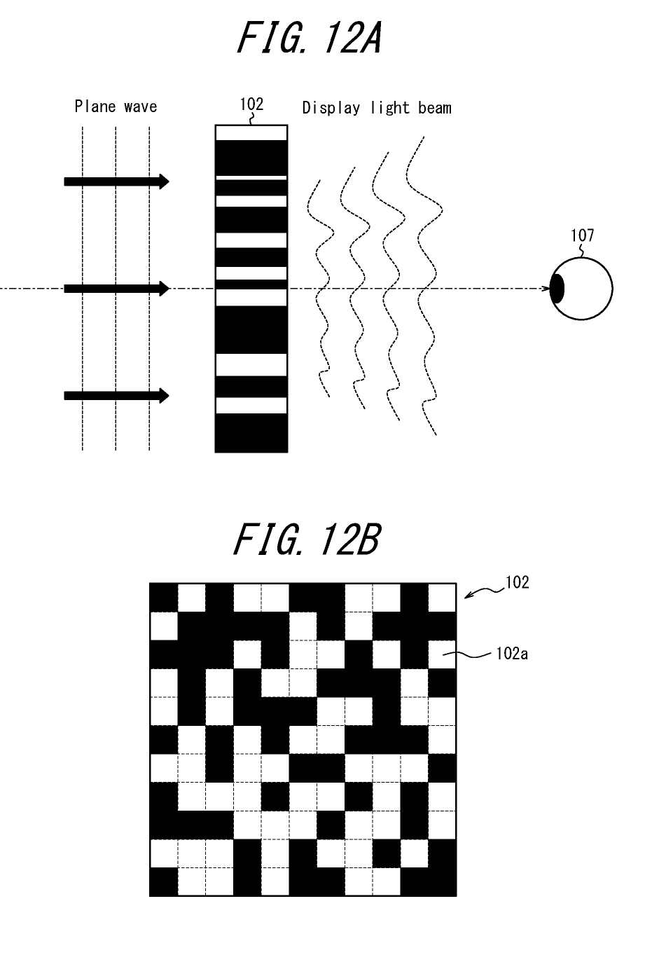

The spatial light modulator 102 transmits or reflects illumination light in a plane wave from the laminated illumination portion 108 and electronically controls the amplitude, phase, polarization, and the like of the optical wavefront. For example, as illustrated by the schematic cross-sectional diagram in FIG. 12A and the schematic plan view in FIG. 12B, the spatial light modulator 102 has multiple light modulator elements 102a arranged in a 2D array. In FIGS. 12A and FIG. 12B, the light modulator elements 102a are indicated as black-and-white rectangular dots. The spatial light modulator 102 is for example configured by a transmissive liquid crystal display (LCD) that performs phase modulation using crystals and is driven by the light modulator driver 104. As a result, the spatial light modulator 102 transmits the illumination light in a plane wave from the laminated illumination portion 108 to generate a display light beam in which the spatial phase distribution of the plane wave is modulated.

The calculator 105 calculates hologram data yielded by quantifying the amount of phase modulation of each light modulator element 102a in the spatial light modulator 102. Hologram data are data quantified for each light modulator element 102a in the spatial light modulator 102 in order to form a hologram pattern in actual space. The hologram data are, for example, provided as a complex amplitude distribution for the spatial light modulator 102 in actual space. In other words, each light modulator element 102a and the minimum unit of hologram data (each piece of modulation amount data) are in one-to-one correspondence. On the other hand, the hologram pattern is a 2D distribution of the physical amount corresponding to the light modulation amount formed by the spatial light modulator 102 and is, for example, a refractive index distribution in the spatial light modulator 102 that modulates the optical phase amount by changing the refractive index. Hologram data may, for example, be calculated using the Gerchberg-Saxton iterative calculation method (GS method; for example, see JP 2004-184609 A).

The controller 106 is connected to the illumination driver 103, light modulator driver 104, and calculator 105. Based on the hologram data output from the calculator 105, the controller 106 drives the spatial light modulator 102 via the light modulator driver 104. As a result, the spatial light modulator 102 forms a hologram pattern. In synchronization with overwriting of the hologram pattern formed in the spatial light modulator 102, the controller 106 sequentially drives the light sources of R light, G light, and B light of the laminated illumination portion 108 via the illumination driver 103. As a result, the illumination light in plane waves of R light, G light, and. B light is emitted sequentially by color from the laminated illumination portion 108 and is incident on the spatial light modulator 102 as reference light.

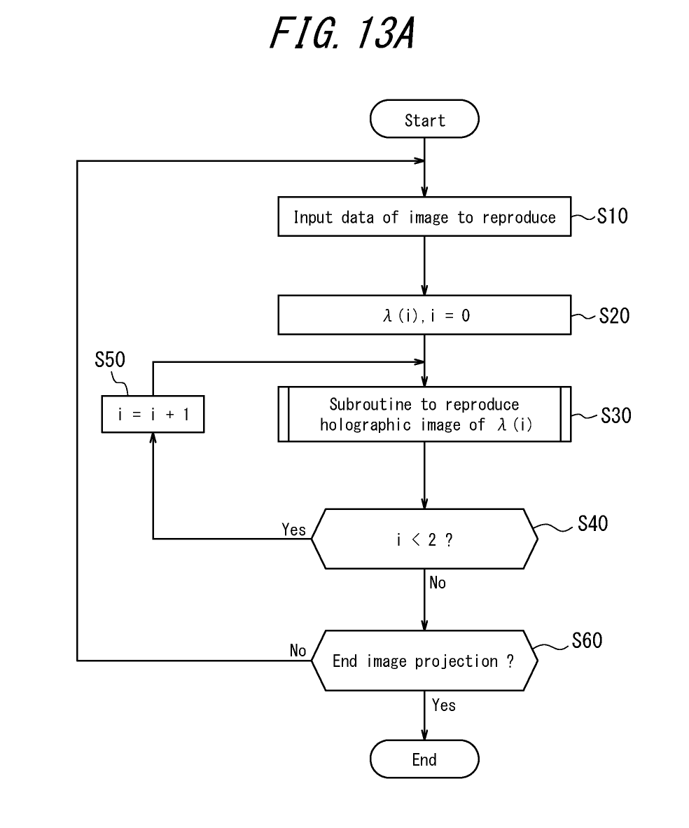

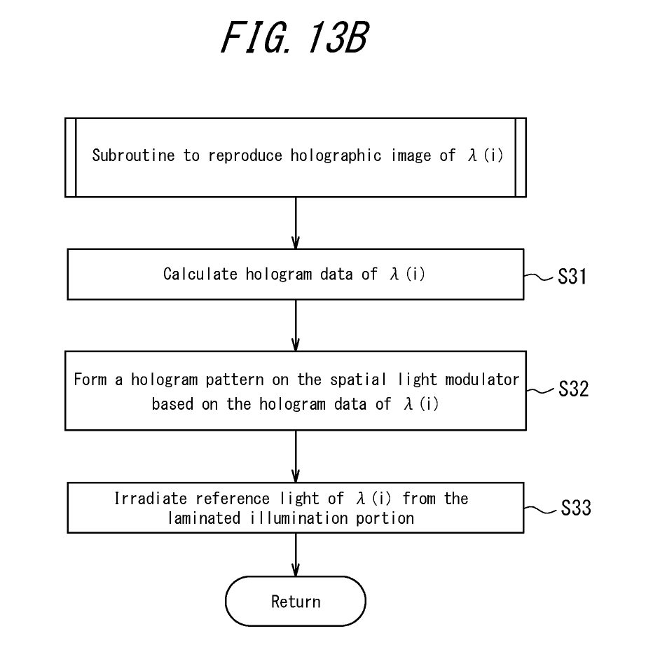

The following describes operations of the display apparatus 100 according to this embodiment with reference to FIGS. 13A, 13B, 14A, 14B, and 15.

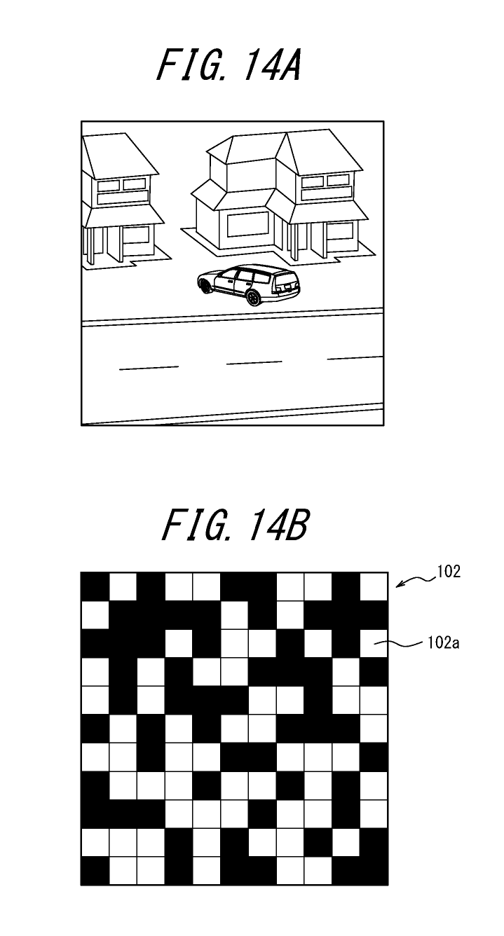

FIG. 13A illustrates the main routine to reproduce a holographic image, and FIG. 13B illustrates a subroutine to reproduce a holographic image. FIGS. 14A and 14B illustrate a method for calculating hologram data. As illustrated in FIG. 13A, in step S10, the controller 106 first inputs data of an image to be reproduced to the calculator 105.

FIG. 14A illustrates an example of an image to be reproduced. The image is not limited to being input from the outside and may instead be generated by the calculator 105. The image may also be data of an object on a 2D plane or data of a stereoscopic image.

Next, in step S20, the controller 106 selects a corresponding wavelength λ(i) for color display. Here, for the sake of convenience, i=0, 1, 2, and λ(0) is R light, λ(1) is G light, and λ(2) is B light. The corresponding wavelengths are not limited to this order. Subsequently, in step S30, the controller 106 transitions to a subroutine for reproducing a holographic image with the corresponding wavelength λ(i).

In the subroutine for reproducing a holographic image, as illustrated in FIG. 13B, in step S31 the controller 106 first calculates hologram data of the corresponding wavelength λ(i) with the calculator 105. When the spatial light modulator 102 emits reference light by a plane wave with the same wavelength as the corresponding wavelength λ(i), the hologram data is calculated as data of the modulation amount for modulating the wavefront of the reference light so as to form nearly the same optical wavefront as the optical wavefront formed by refraction by an image disposed at infinity. The hologram data are, fir example, derived by the GS method using a fast Fourier transform.

Next, in step S32, the controller 106 forms a hologram pattern in the spatial light modulator 102 via the light modulator driver 104 based on the hologram data calculated by the calculator 105. In other words, the controller 106 controls each light modulator element 102a via the light modulator driver 104 to form a 2D distribution of the amount of phase modulation. As a result, a pattern based on the hologram data calculated by the calculator 105 is formed in the spatial light modulator 102.

FIG. 14B illustrates an example of a hologram pattern formed on the spatial light modulator 102. In FIG. 14B, one black and white rectangular dot of hologram data is a minimum unit of data among the hologram data and corresponds to the amount of phase modulation of a light modulator element 102a in actual space. The hologram data do not need to be two values, i.e. black and white, as illustrated in FIG. 14B and may for example have many values.

Subsequently, in step S33, the controller 106 drives the light source of the illumination portion of the corresponding wavelength λ(i) in the laminated illumination portion 108 via the illumination driver 103 and emits reference light with a plane wave of the corresponding wavelength λ(i) from the laminated illumination portion 108. As a result, reference light is emitted as a plane wave of the corresponding wavelength λ(i) into the spatial light modulator 102.

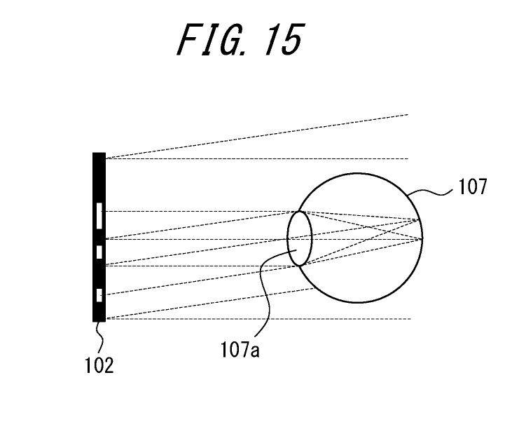

FIG. 15 illustrates image reproduction on the eyeball 107 of an observer from the spatial light modulator 102. The hologram pattern formed in the spatial light modulator 102 is calculated by the calculator 105 so as to generate an optical wavefront that is estimated when forming a virtual image disposed at infinity. Accordingly, when reference light as a plane wave is irradiated onto the spatial light modulator 102, the display light beam that is modulated and transmitted forms a virtual image at infinity for the image. In other words, any point in the image is emitted as a parallel beam of light having a predetermined angle relative to the spatial light modulator 102. The emitted parallel beam of light forms a point image by being collected on the retina for example due to the effect of refraction by the lens 107a of the eyeball 107. At this time, the angle of the beam of light emitted from the spatial light modulator 102 is equivalent to the angle at which the observer sees the point image. Since a plurality of parallel beams of light are emitted simultaneously at different angles from the spatial light modulator 102, an image is formed on the retina.

As illustrated in FIG. 13A, in step S40, the controller 106 repeats the processing in step S30 while incrementing i in step S50 until reaching i=2. As a result, hologram patterns corresponding to R, G, and B are formed sequentially by color on the spatial light modulator 102, and reference light of each corresponding color is emitted. The controller 106 repeats steps S10 to S60 until image projection is complete in step S60.

As a result, the image on the observer's retina is displayed as a virtual image positioned at infinity. Accordingly, by fixing the image that is reproduced and repeating step S10 through step S60, a still image can be displayed in color, and by repeating step S10 through step S60 while sequentially changing the image that is reproduced, a moving image can be displayed in color.

With the display apparatus 100 according to this embodiment, a still image or moving image of a color holographic image in which the optical wavefront of an image is reproduced can be observed. Furthermore, the display apparatus 100 emits reference light in plane waves of R light, G light, and B light using the laminated illumination portion 108 with the structure illustrated in Embodiments 2 to 4. Therefore, the laminated illumination portion 108 can be reduced in thickness and in size, thus reducing the entire apparatus in thickness and in size.

### Embodiment 6

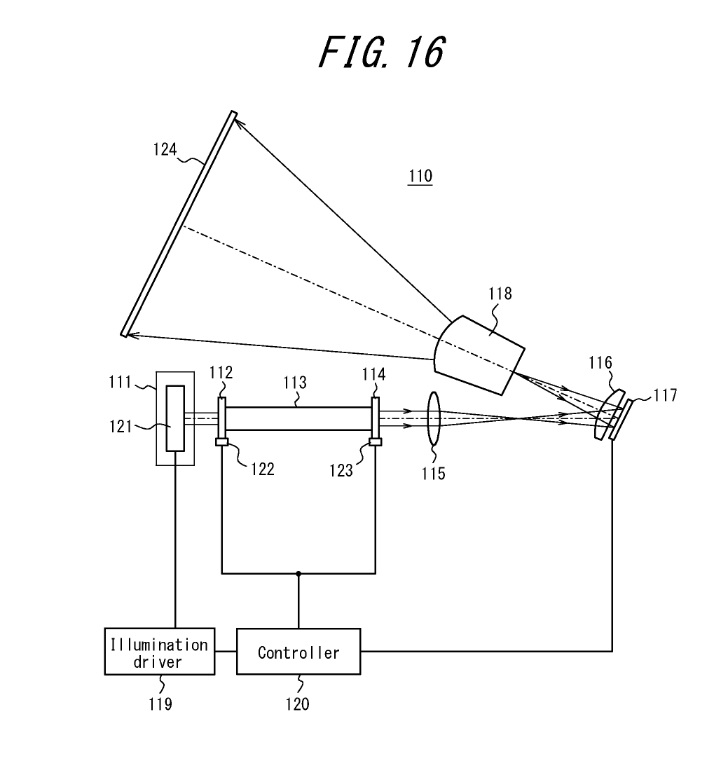

FIG. 16 schematically illustrates the structure of a display apparatus according to Embodiment 6. A display apparatus 110 illustrated in FIG. 16 constitutes a projection display apparatus and includes an illumination apparatus 111, a first optical diffusion device 112, a rod integrator 113, a second optical diffusion device 114, a condenser lens 115, a field lens 116, a reflecting display device 117, a projection lens 118, an illumination driver 119, and a controller 120.

The illumination apparatus 111 includes the illumination apparatus described in Embodiments 2 to 4 and a laminated illumination portion 121 that can emit illumination light in plane waves of R light, G light, and B light in plane form in the same direction. The laminated illumination portion 121 is driven by the controller 120 via the illumination driver 119 and emits illumination light in plane waves of R light, G light, and B light sequentially by color.

The illumination light emitted from the laminated illumination portion 121 is diffused by the first optical diffusion device 112 and is incident on the rod integrator 113. The illumination light incident on the rod integrator 113 is propagated while repeatedly being reflected inside the rod integrator 113, is emitted from the rod integrator 113, and is further diffused by the second optical diffusion device 114. In this embodiment, ultrasonic motors 122 and 123 are fixed to the first optical diffusion device 112 and the second optical diffusion device 114. By one or both of the ultrasonic motors 122 and 123 being driven by the controller 120, one or both of the first optical diffusion device 112 and the second optical diffusion device 114 can be vibrated slightly in the perpendicular direction relative to the optical axis.

The illumination light diffused by the second optical diffusion device 114 passes through the condenser lens 115 and the field lens 116 and is irradiated onto the reflecting display device 117. The reflecting display device 117 is, for example, configured by a Digital Micromirror Device (DMD), and the driving thereof is controlled by the controller 120. The DMD is provided with multiple minute mirrors and modulates illumination light by the angle of each mirror being controlled by the controller 120 based on a video signal.

The illumination light irradiated by the reflecting display device 117 is modulated by the reflecting display device 117 in accordance with the video signal. The modulated light from the reflecting display device 117 passes through the field lens 116 and is expanded and projected onto a screen 124 by the projection lens 118. The position of the entrance surface of the beam of light on the reflecting display device 117 has a conjugate relationship with the position of the exit surface on the rod integrator 113 and the position of the projection surface on the screen 124.

The display apparatus 110 according to this embodiment controls the laminated illumination portion 121 via the illumination driver 119 and controls the reflecting display device 117 with the controller 120 in accordance with a video signal. As a result, the display apparatus 110 can provide color display with a method that is sequential by color. By controlling the ultrasonic motors 122 and 123 with the controller 120, the display apparatus 110 can slightly vibrate one or both of the first optical diffusion device 112 and the second optical diffusion device 114 in the perpendicular direction relative to the optical axis. As a result, in addition to the effect of diffusing the beam of light with the first optical diffusion device 112 and the second optical diffusion device 114, a speckle pattern can be changed and overlaid by variation in one or both of the first optical diffusion device 112 and the second optical diffusion device 114, allowing speckles to be nearly completely eliminated. Accordingly, an image in which speckles, which are unpleasant for the observer, are nearly completely removed can be projected onto the screen 124. Furthermore, the display apparatus 110 emits reference light in plane waves of R light, G light, and B light using the laminated illumination portion 121 with the structure illustrated in Embodiments 2 to 4. Therefore, the laminated illumination portion 121 can be reduced in thickness and in size, thus reducing the entire apparatus in thickness and in size.

This disclosure is not limited to the above embodiments, and a variety of changes and modifications may be made. For example, in Embodiments 1 to 4, the emission directions of illumination light from the illumination portions thrilling the laminated illumination portion are not limited to being the same direction and may be any direction for each illumination portion. Also, the laminated portions may be layered in any order, as long as the height of the grating of each illumination portion is constant. Furthermore, the illumination portions are not limited to the three colors of R light, G light, and B light and may be any two or more colors.

1. An illumination apparatus comprising:
a laminated illumination portion formed by layering a plurality of illumination portions each configured to emit illumination light as a plane wave with a different wavelength;
wherein each illumination portion comprises a light source configured to emit light of a predetermined wavelength, an optical waveguide configured to propagate the light emitted from the light source, and a grating configured to diffract the light propagating through the optical waveguide and emit the light as the illumination light.

2. The illumination apparatus of claim 1, wherein the laminated illumination portion emits the illumination light with a different wavelength from each illumination portion in a same direction.

3. The illumination apparatus of claim 1, wherein the optical waveguide is formed by a single mode optical waveguide.

4. The illumination apparatus of claim 1, wherein the optical waveguide is formed by a slab-type optical waveguide.

5. The illumination apparatus of claim 1, wherein the grating increases in height in a propagation direction of the light that propagates through the optical waveguide.

6. The illumination apparatus of claim 1, wherein in the laminated illumination portion, the plurality of illumination portions are layered in a direction of emission of the light, in order of decreasing wavelength of the illumination light so that the illumination portion with shorter wavelength is located on an emission side of the illumination portion with longer wavelength.

7. A display apparatus comprising:
the illumination apparatus of claim 1;
a calculator configured to calculate an amount of modulation necessary to form a wavefront shape of a display light beam at each wavelength of the illumination light from the illumination apparatus;
a spatial light modulator configured to subject the illumination light from the illumination apparatus to spatial modulation based on the amount of modulation calculated by the calculator; and
a controller configured to control driving of the laminated illumination portion of the illumination apparatus and the spatial light modulator;
wherein the calculator calculates the amount of modulation necessary for each wavelength of the illumination light in accordance with a display image; and
wherein the controller drives the illumination portions of the laminated illumination portion and the spatial light modulator in synchronization at each wavelength of the illumination light in accordance with the display image.

8. A display apparatus comprising:
the illumination apparatus of claim 1;
a display configured to display an image with the illumination light from the illumination apparatus;
a projection optical unit configured to project an image formed on the display; and
a controller configured to control driving of the laminated illumination portion of the illumination apparatus and the display;
wherein the controller drives the illumination portions of the laminated illumination portion and the display in synchronization at each wavelength of the illumination light.
